(19) United States
(12) Patent Application Publication
(10) Pub. No.: US 2025/0173769 A1
(43) Pub. Date: May 29, 2025

(54) GREEN HYDROGEN DISPATCH

(71) Applicant: Inventus Holdings, LLC, Juno Beach, FL (US)

(72) Inventors: Ian J. FISKE, Jacksonville, FL (US); William G. Kemmerer, IV, North Palm Beach, FL (US); Christopher G. Nunalee, North Palm Beach, FL (US); Sriharsha Veeramachaneni, Minneapolis, MN (US)

(21) Appl. No.: 18/522,685

(22) Filed: Nov. 29, 2023

(51) Int. Cl. G06Q 30/0283; G06Q 50/06; H02J 15/00

(52) U.S. Cl. CPC G06Q 30/0283; G06Q 50/06; H02J 15/008

(57) ABSTRACT

Systems and methods to controlling green hydrogen production. A cost of an incremental amount of renewable energy and a marginal amount of hydrogen generated by the incremental amount of renewable energy are determined. An amount of incentive payments available for the marginal amount of hydrogen is determined. A total production cost is compared to a revenue value of the marginal amount of hydrogen that is determined by adjustment of the cost of the incremental amount of renewable energy by the amount of incentive payments. Operating parameters of the hydrogen producing electrolyzer are adjusting, based on a relationship between the total production cost and the present revenue value of the marginal amount of hydrogen, to one of increase or decrease an amount of produced hydrogen.

### FIELD OF THE DISCLOSURE

The present disclosure generally relates to controlling the operation of industrial equipment, and more particularly to determining equipment operating parameter values based upon various conditions.

### BACKGROUND

Industrial equipment, such as are used in industrial plants that produce chemicals or other products, are often operated under various constraints such as environmental constraints, regulatory constraints, contractual constraints, and the like. Examples of such industrial equipment include equipment operating in green hydrogen production systems. In an example, a green hydrogen production system is a system that produces hydrogen by consuming energy that is either partially or wholly supplied by renewable energy generation systems. Green hydrogen production systems generally include one or more renewable energy production systems, such as wind or solar electrical power generation systems, and chemical production systems such as electrolyzers, and in some cases other components such as liquifiers, storage, and electrical energy storage battery systems. Such systems are able to have many constraints imposed on their operation such as constraints imposed by physical limitations set by, for example, operating limits of equipment. Other constraints imposed in some scenarios include economic requirements such as operational requirements that control an ability to earn hydrogen generation production tax credits (PTCs).

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 illustrates a green hydrogen production system, according to an example;

FIG. 2 illustrates an electrolyzer control architecture, according to an example;

FIG. 3 illustrates a green hydrogen economics improvement data flow, according to an example;

FIG. 4 illustrates a green hydrogen processing flow, according to an example;

FIG. 5 illustrates an electrolyzer operating parameter adjustment processing flow, according to an example;

FIG. 6 illustrates a prospective electrolyzer operating parameter determination processing flow, according to an example; and

FIG. 7 illustrates components contained within an example wind turbine nacelle, according to an example.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the disclosed subject matter in virtually any appropriately detailed structure and function. Further, the terms and phrases used herein are not intended to be limiting, but rather, to provide an understandable description.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The below described systems and methods operate to improve the economic return of operating a green hydrogen production system. Green hydrogen in the context of this discussion generally refers to hydrogen gas (H₂) that is produced by energy created from renewable resources. For example, green hydrogen includes hydrogen that is produced by electrolysis using electricity generated from renewable energy sources such as wind or solar. In the following discussion, renewable energy includes electricity that is generated from renewable energy.

Various incentives for the production of green hydrogen are able to specify a range of requirements, limitations, conditions, other specifications, or combinations of these, to qualify for the incentive or to qualify for higher value incentives. For example, production of a unit of green hydrogen may have different incentives values based on an amount of carbon dioxide that is emitted during the production of that unit of green hydrogen. Another example of a qualification for some incentives for the production of green hydrogen is that the electrolyzer is required use electricity generated from a renewable energy source, but other electrical elements of the green hydrogen facility such as ventilation fans, etc., are able to be powered by electricity generated by any means.

The below described systems and methods utilize one or more algorithms to determine operating parameters for a green hydrogen production system that improves the economic return of that green hydrogen production. The algorithms used by the below described systems and methods incorporate the requirements, limitations, conditions, other specifications, or combinations of these, that are specified by regulations or required to qualify for incentives when determining the operating parameters for the green hydrogen production system. The operation of the below described systems and methods go beyond improving the green hydrogen production system based on the physical characteristics and resource usage of the system, but further include the economic benefits of various green hydrogen production incentives. In some examples, the economic benefit of operating a green hydrogen production system is increased by including consideration of production incentives in determining operating parameters to increase the overall economic return of operation of that green hydrogen production system. In some examples, in addition to green hydrogen production incentives, operational efficiency curves of the equipment are also included in the algorithm to determine operational parameters of a green hydrogen production system.

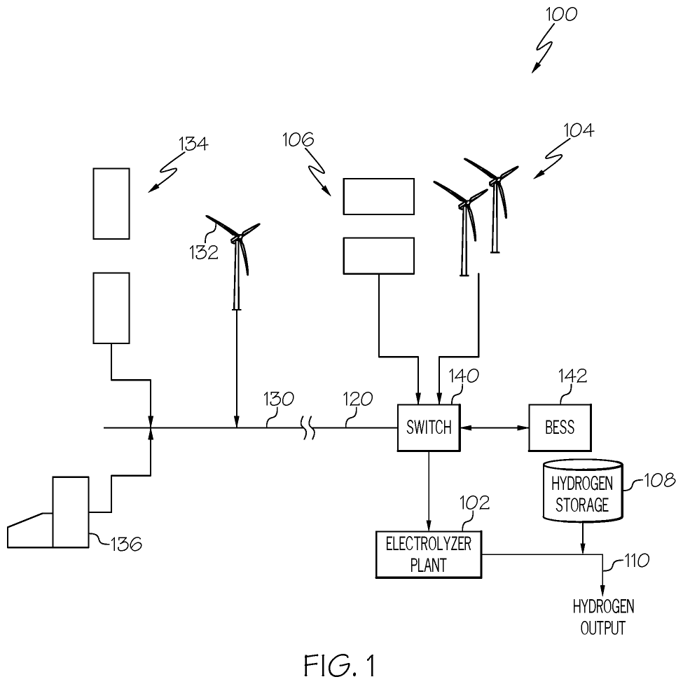

FIG. 1 illustrates a green hydrogen production system 100, according to an example. The green hydrogen production system 100 is an example of a system that receives renewable energy from local renewable energy generation systems, remote renewable energy generation systems, or combinations of these, and uses that energy to produce green hydrogen.

The illustrated green hydrogen production system 100 includes an electrolyzer plant 102 that receives electrical energy that produces hydrogen gas. The electrical energy in the illustrated example is able to be received from one or both of local renewable energy generation source, which are examples of a collocated renewable energy generation source such as one or more wind turbines 104 or a solar panel array 106, or remote renewable energy sources via an external power connection 120. The hydrogen produced by the electrolyzer plant 102 is able to be provided to either a hydrogen output 110 or to a hydrogen storage system 108 for storage. Hydrogen stored in the hydrogen storage system 108 is able to be provided to the hydrogen output 110 at other times.

The illustrated local renewable energy sources, including the wind turbines 104 and solar panel array 106, in an example are located generally near the electrolyzer plant 102 and are connected to a local electrical energy interconnection system 140. The illustrated local electrical energy interconnection system 140 in this example is also connected to the external power connection 120 and a local battery energy storage system (BESS) 142. The BESS 142 is able to store either excess electrical energy as it is produced by the local renewable energy sources or energy that is received via the external power connection 120.

The illustrated green hydrogen production system 100 depicts remote energy generation sources that include a remote wind farm 132, a remote solar farm 134, and non-renewable generators 136. These remote energy generation sources produce electrical power that is provided to a transmission/distribution system 130 and is able to be delivered to the electrolyzer plant 102. The remote wind farm 132 and remote solar farm 134 are examples of remote renewable energy sources that produce energy that qualifies the electrolyzer plant 102 to operate as a green hydrogen generator. In some examples, a green hydrogen production system is able to use electricity that is remotely generated by renewable energy and transmitted to the green hydrogen production system by having arrangements in place to ensure that the electricity received and used by the green hydrogen production system was in fact generated by renewable energy. The remote energy generation sources in this example include non-renewable generators 136, which are able to include electrical generators, such as natural gas-powered generators, that produce electricity whose use might impact on the ability of the electrolyzer plant 102 to qualify as operating as a green hydrogen generator. In some examples, a green hydrogen production system is able to use a limited quantity of electricity from non-renewable generators 136 based on the requirements of the incentive programs in which the green hydrogen production system is participating.

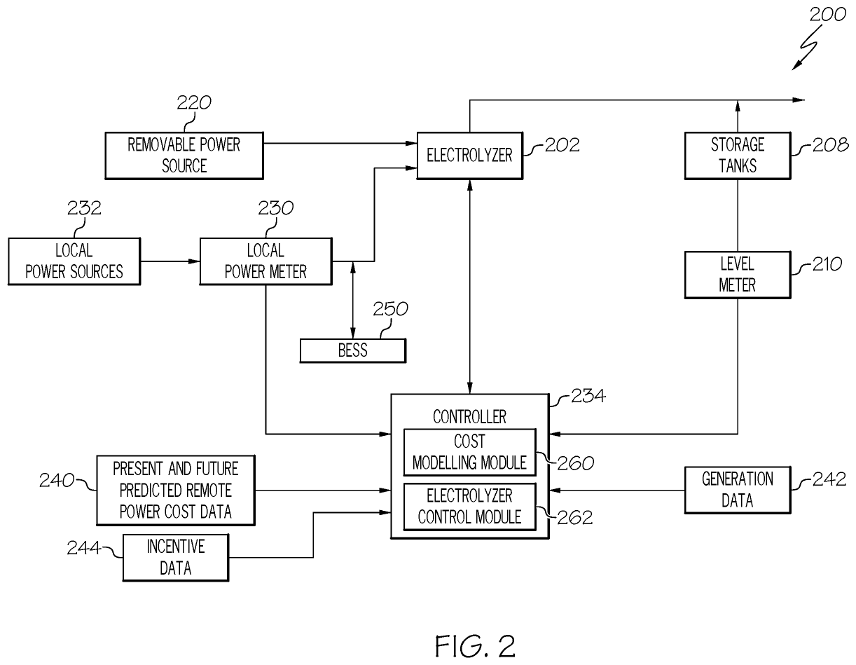

FIG. 2 illustrates an electrolyzer control architecture 200, according to an example. The electrolyzer control architecture 200 depicts components and data sources that are used to control the operation of an electrolyzer 202. The illustrated electrolyzer 202 is an example of equipment that is able to be installed within the above described electrolyzer plant 102. The electrolyzer 102 in this example is able to receive electrical power from either local renewable energy sources 232 or from remote power sources 220

The electrolyzer control architecture 200 depicts a controller 234 that receives various data items from a number of sources in order to determine values for operating parameters of the electrolyzer 202. In the illustrated example, the controller 234 receives present and projected future remote power cost data 240, present incentive data 244 from remote sources such as regulators, power utility pools, other sources, or combinations of these. A local power meter 230 measured the amount of electric power being generated by local renewable energy sources 232, which in the above-described example are able to include one or more of the local wind turbines 104 and local solar panel array 106.

The controller 234 further receives storage level indications as measured by level meter 210. Level meter 210 in an example measures the level of hydrogen being stored in hydrogen storage tanks 208. In some examples, the electrolyzer 202 is able to be operated to generate hydrogen to be stored in the storage tanks 208 in order to allow that hydrogen to be delivered at a later time such as when the market price of that hydrogen may be higher.

In an example, the controller 234 is an example of a green hydrogen production controller that includes a cost modelling module 260 and an electrolyzer control module 262. In various examples, cost modelling module 260 of the controller 234 evaluates the net total cost of generating a unit of hydrogen based upon quantities such as the cost of electricity sourced from renewable energy sources to generate that unit of hydrogen and the value of incentives that are able to be received for the generated unit of hydrogen. In some examples, the value of units of locally generated electricity is determined based on the present price paid for a unit of renewably generated electricity. In some examples, if the net total cost of generating a unit of hydrogen by using units of locally generated electricity exceeds the price paid by other users for those units of electricity, those units of locally generated electricity are delivered and sold to the power grid, such as via the external power connection 120 instead of being used to generate hydrogen.

The controller 234 in some examples includes data reflecting different values of efficiency at which the electrolyzer 202 operates when operating at different levels of output. For example, when the electrolyzer 202 operates at a maximum capacity, it uses a higher amount of electricity per unit of hydrogen being produced than when operating at lower production levels.

The controller 234 in some examples operates to improve or optimize the economic return of operating the green hydrogen production system 100 by producing hydrogen at its most profitable level or, based on the value of generated electricity, selling locally generated electricity to the electric grid or other buyers instead of operating the electrolyzer 202. Based on varying efficiency levels of the electrolyzer 202 at different hydrogen output levels, the controller 234 is able to improve the economic return of operating the green hydrogen production system by operating the electrolyzer 202 at a reduced output level relative to the amount of available locally generated electricity to more efficiently produce hydrogen, and then selling the excess locally generated electricity for other uses, such as to an electric grid or other user of electricity.

The controller 234 in some examples further controls a battery energy storage system (BESS) 250 to cause the BESS 250 to accumulate energy from one or both of the local renewable energy sources 232 or the remote renewable energy sources 220. In some examples, the controller 234 improves the economic return of operating the green hydrogen production system 100 based upon historic values of one or more of generated green hydrogen, generated electricity, costs of remotely generated electricity, other quantities, or any combination of these.

Based on processing the above described data elements that received or stored in the controller 234, the electrolyzer control module 262 determines operating parameters for the electrolyzer 202 as is described below.

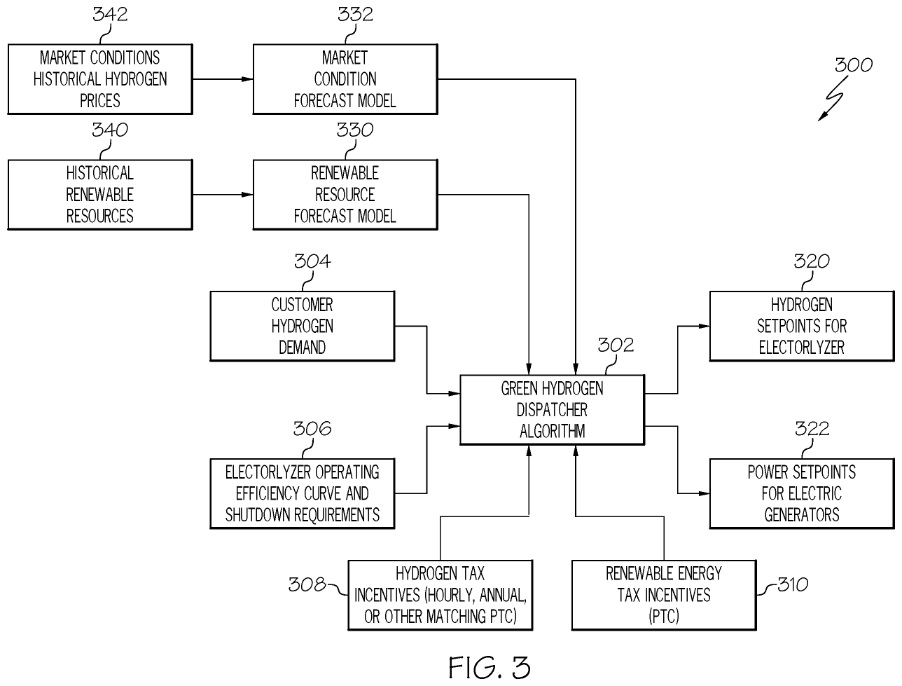

FIG. 3 illustrates a green hydrogen economics improvement data flow 300, according to an example. With reference to the above described electrolyzer control architecture 200, the green hydrogen economics improvement data flow 300 depicts an example of data received by the controller 234 and also the control parameters produced by the controller 234 based on that data.

The green hydrogen economics improvement data flow 300 illustrates a green hydrogen dispatcher algorithm 302. The green hydrogen dispatch algorithm 302 is an example of an algorithm calculated by the above described controller 234 in order to cause the electrolyzer 202 to produce a determined amount of hydrogen. In the present discussing, controlling an amount of hydrogen produced by the green hydrogen production system 100 is referred to as dispatch.

The green hydrogen economics improvement data flow 300 depicts customer hydrogen demand 304 that is provided to the green hydrogen dispatcher algorithm 302. Customer hydrogen demand 304 in some examples indicates values that an amount of hydrogen has in the customer market. In various examples, customer hydrogen demand is able to be specifies as a constant value, a time varying value, a value that varies with the amount of hydrogen sold per unit time, values specified in other ways, or combinations of one or more of these.

The green hydrogen economics improvement data flow 300 depicts electrolyzer operating efficiency curve and shutdown requirements 306 that are provided to the green hydrogen dispatcher algorithm 302. The electrolyzer operating efficiency curve and shutdown requirements 306 in some examples indicate the efficiency of the electrolyzer, e.g., specifies an amount of electricity consumed by the electrolyzer at per unit of hydrogen production, for various rates of hydrogen production. The electrolyzer operating efficiency curve and shutdown requirements 306 also specifies operational procedures, such as maximum design ramp rates, to be used when increasing or reducing the hydrogen output of the electrolyzer 202.

The green hydrogen economics improvement data flow 300 depicts example hydrogen tax incentives (hourly, annually, or other matching Production Tax Credits (PTC)) 308 and the renewable energy tax incentives PTC 310 that are provided to the green hydrogen dispatcher algorithm 302. The hydrogen tax incentives (hourly, annually, or other matching Production Tax Credits (PTC)) 308 and the renewable energy tax incentives PTC 310 in some examples indicate amounts of incentives that are available for the production of green hydrogen. In some examples, these values are fixed over a particular time period. In further examples, these values by vary by time or based on one or more various criteria.

The green hydrogen economics improvement data flow 300 depicts a historical renewable resources dataset 340 that feeds a renewable resource forecast model 330 that provides forecasts of renewable resource availability and pricing to the green hydrogen dispatcher algorithm 302. The historical renewable resources dataset 340 in some examples includes data that indicates the availability and cost of renewable resources, such as electricity generated by renewable energy, over various times and given various conditions such as environmental conditions, other conditions, or combinations of these. This data is provided to the renewable resource forecast model 330 that creates, maintains, and updates a model to provide forecasts of renewable resource availability and pricing based on various specified criteria such as upcoming environmental conditions including, but not limited to, weather conditions, ambient temperatures, other conditions, or combinations of these.

The green hydrogen economics improvement data flow 300 depicts a market conditions/historical hydrogen pricing dataset 342 that feeds a market condition forecast model 332 that provides forecasts of hydrogen pricing to the green hydrogen dispatcher algorithm 302. The market conditions/historical hydrogen pricing dataset 342 that feeds a market condition forecast model 332 in an example support determination of historical customer demand for green hydrogen at various price points in order to support determination of estimated revenue per unit of hydrogen produced at a future time. The historical renewable resources dataset 340 in some examples includes data that indicates the demand and pricing data for green hydrogen over time given various conditions such as various environmental conditions, other conditions, or combinations of these. This data is provided to the market conditions forecast model 332 that creates, maintains, and updates a model to provide forecasts of prices and demand of green hydrogen as a function of various conditions such as upcoming environmental conditions such as weather conditions, ambient temperatures, other conditions, or combinations of these.

The green hydrogen dispatcher algorithm 302 receives the above information and processes that information by a suitable algorithm to determine an amount of green hydrogen to produce at various times. The green hydrogen dispatcher algorithm 302 produces operating parameters for the electrolyzer 202 such as the illustrated hydrogen output set points for electrolyzer 320 and power set points for electric generators 322.

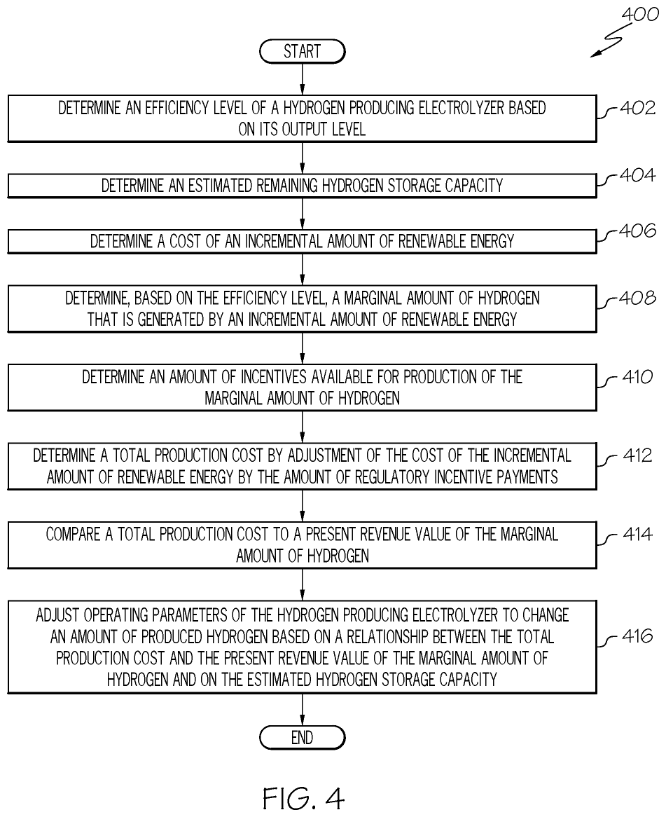

FIG. 4 illustrates an electrolyzer operating parameter determination processing flow 400, according to an example. The following descriptions refer to the above described electrolyzer control architecture 200. The electrolyzer operating parameter determination processing flow 400 is an example of a process performed by the controller 234 to support the operation of the electrolyzer 202.

The electrolyzer operating parameter determination processing flow 400 determines, at 402, an efficiency level of a hydrogen producing electrolyzer based on its output level. In some examples, each electrolyzer has an efficiency curve that reflects a variation in electrolyzer efficiency, i.e., the amount of hydrogen produced per unit of electric energy, as a function of the electrolyzer's hydrogen production rate. In various examples, an electrolyzer efficiency curve for each electrolyzer is able to be obtained by any suitable method such as measurements made by past operations, from manufacturer data, from other techniques, or combinations of these.

An estimated remaining hydrogen storage capacity is determined, at 404. The hydrogen storage capacity is determined in an example by the above described level meter 210 that provides an indication of the amount of hydrogen that can be stored in the storage tanks 208. The amount of hydrogen that can be stored, and thus potentially delivered to customers at a higher price, rather than provided as a current output of the system may impact the amount of hydrogen to be produced when evaluating the economic return of operating the electrolyzer 204.

A cost of an incremental amount of renewable energy is determined at 406. In various examples, an incremental amount of energy is any amount of energy consumption by which the processing is evaluating to change the energy consumption of the electrolyzer 202. Such evaluations are able to either increase or decrease the energy consumption of the electrolyzer 202 by this incremental amount of energy. In various examples, the electrolyzer operating parameter determination processing flow 400 is able to iteratively evaluate different amounts of incremental energy. The cost of the incremental amount of renewable energy is able to be determined by any suitable technique. For renewable energy obtained from remote renewable energy systems, the operators of those systems or other entities are able to set a price for incremental amounts of energy. When evaluating the use of an incremental amount of energy generated by a local renewable energy generation sources, the cost of that incremental amount of energy is based on a net value of that amount of incremental energy that would be received if it were sold to other consumers such as via the external power connection 120.

A marginal amount of hydrogen that is generated by an incremental amount of renewable energy is determined based on the efficiency level of the electrolyzer, at 408. In general, determining this amount of hydrogen is able to be based on information received via one or more techniques, such as previous monitoring of the performance of the electrolyzer as its input power is varied. It is a characteristic of some electrolyzers that their efficiency decreases as their output, and thus also their input power, increases. This characteristic can result in diminishing increases in hydrogen output as the electric power input increases.

An amount of incentives available for production of the marginal amount of hydrogen is determined, at 410. In some examples, incentive payments may have conditions that have to be met before a produced quantity of hydrogen will qualify for the incentive. Such conditions may include, but are not limited to, the source of the electric energy used to produce the hydrogen, a cap on the amount of hydrogen produced over a specified time period, other conditions, or combinations of these. Determining the amount of incentive payments is based on verifying or otherwise confirming compliance with the conditions associated with each available incentive of the process used to generate the incremental amount of hydrogen.

A total production cost by adjustment of the cost of the incremental amount of renewable energy by the amount of incentives is determined at 412. This determination in some examples includes subtracting the value of the incentives from the cost of the incremental amount of energy. In various examples, other operating costs are also added to the total production cost such as maintenance cost of equipment including the electrolyzer 204.

A total production cost is compared to a present revenue value of the marginal amount of hydrogen, at 414. This comparison determines if the production of the marginal amount of hydrogen is economically beneficial.

Operating parameters of the hydrogen producing electrolyzer are adjusted to change an amount of produced hydrogen based on a relationship between the total production cost and the present revenue value of the marginal amount of hydrogen and on the estimated hydrogen storage capacity, at 416. In an example, the marginal amount of hydrogen is produced if it is determined that the total production cost is less than a present revenue value of that marginal amount of hydrogen. The marginal amount of hydrogen is not produced in this example if the total production cost is more than a present revenue value of that marginal amount of hydrogen. The electrolyzer operating parameter determination processing flow 400 then ends.

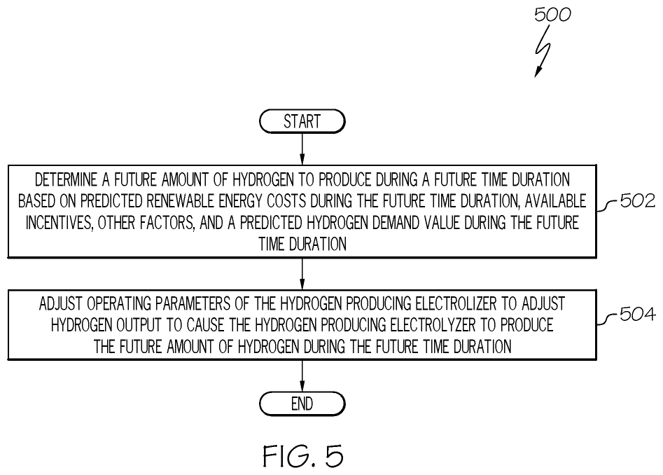

FIG. 5 illustrates an electrolyzer operating parameter adjustment processing flow 500, according to an example. The electrolyzer operating parameter adjustment processing flow 500 is an example of a process performed by the controller 234 to support the operation of the electrolyzer 202.

The electrolyzer operating parameter adjustment processing flow 500 determines, at 502, a future amount of hydrogen to produce during a future time duration based on predicted renewable energy costs during the future time duration, available incentives, other factors, and a predicted hydrogen demand value during the future time duration. The predicted renewable energy costs are able to be predicted in a number of ways such as incorporating weather forecasts to estimate solar energy or wind availability at renewable energy generation sites, terms of supply contracts, other means, or combinations of these. Other factors that may be included in this determination include, but are not limited to, available hydrogen storage capacity, operating conditions of the production equipment such as electrolyzer maintenance, other factors, or combinations of these. Prediction of hydrogen demand may not correlate with actual future demand but can be a useful guide for hydrogen production decisions. Prediction of hydrogen demand is able to be based on various techniques such as historical demand patterns, estimated economical cost of production, and related thereto its ultimate sales price, of the produced hydrogen, other techniques, or combinations of these.

Operating parameters of the hydrogen producing electrolyzer are adjusted, at 504, to adjust hydrogen output to cause the hydrogen producing electrolyzer to produce the future amount of hydrogen during the future time duration. Such operating parameters are able to be determined based on characteristics of the production equipment, such as the electrolyzer 202. The characteristics of the production equipment are able to be determined by any suitable technique such as measurements and observations of past operations. In some examples, adjustment of operating parameters of the electrolyzer includes limits on the operation of the electrolyzer such as limits for up time of the electrolyzer, limits on the time rate of change of those parameters due to, for example, design limitations of ramp rates for the rate of change of the production of hydrogen by the electrolyzer, other factors, or combinations of these.

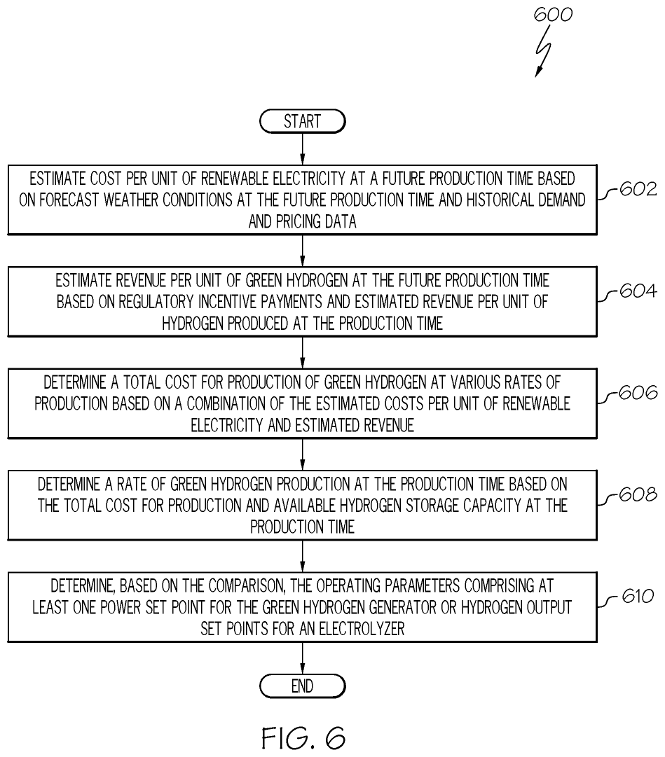

FIG. 6 illustrates a prospective electrolyzer operating parameter determination processing flow 600, according to an example. The prospective electrolyzer operating parameter determination processing flow 600 is an example of a process performed by the controller 234 to support the operation of the electrolyzer 202.

The prospective electrolyzer operating parameter determination processing flow 600 estimates, at 602, the cost per unit of renewable electricity at a future production time based on forecast weather conditions at the future production time and historical demand and pricing data. This cost is able to be estimated based on any suitable technique, such as an amount of revenue is revenue that would be collected for the sale of renewable energy that is generated, such as by the local renewable energy generation sources, and that would otherwise be available be used to generate green hydrogen.

Revenue per unit of green hydrogen produced at the future production time is estimated, at 604, based on regulatory incentive payments received per unit of hydrogen produced at the future production time and estimated revenue per unit of hydrogen produced at the production time. Estimations of demand are able to be based on various data such as historic demand trends, predicted demands due to weather, seasonal demand factors, other data, or combinations of these.

A total cost for production of green hydrogen at various rates of production is determined, at 606, based on a combination of the estimated costs per unit of renewable electricity and estimated revenue. The determination of these total costs includes consideration of incentive payments available per unit of hydrogen produced at the production time, and the estimated efficiency of the green hydrogen generation system at each considered rate of green hydrogen production, the estimated revenue per unit of hydrogen produced at the production time, and the hydrogen storage capacity at the production time.

A rate of green hydrogen production at the production time is determined, at 608, based on the total cost for production and available hydrogen storage capacity at the production time. In an example, the determined rate of green hydrogen production is selected to be at a level that maintains a desired profit over the total costs of its production.

The operating parameters comprising at least one power set point for the green hydrogen generator or hydrogen output set points for an electrolyze are determined, at 610, based on the above comparison. Such operating parameters are able to be determined based on characteristics of the production equipment, such as the electrolyzer 202. The characteristics of the production equipment are able to be determined by any suitable technique such as measurements and observations of past operations. The prospective electrolyzer operating parameter determination processing flow 600 then ends.

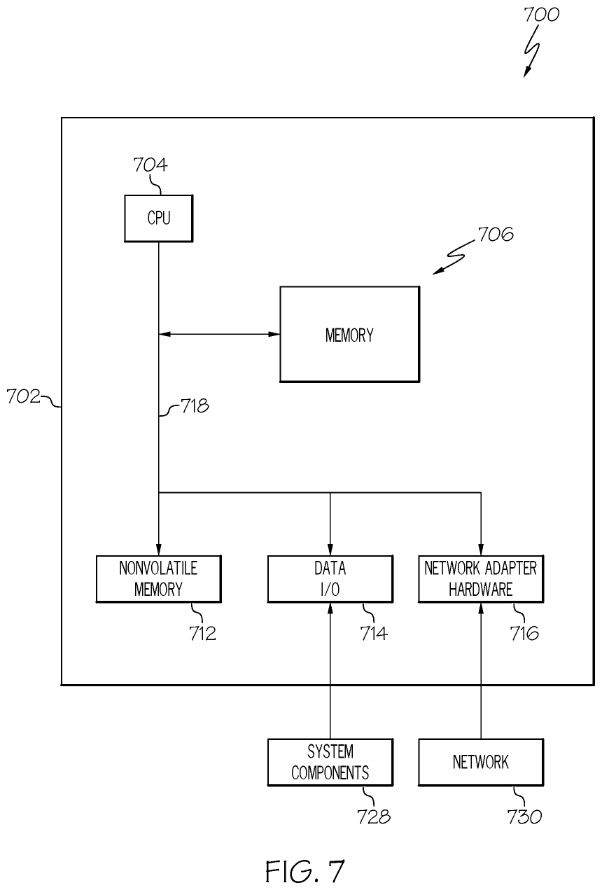

FIG. 7 illustrates a block diagram illustrating a controller 700 according to an example. The controller 700 is an example of a processing subsystem that is able to perform any of the above described processing operations, control operations, other operations, or combinations of these.

The controller 700 in this example includes a CPU 704 that is communicatively connected to a main memory 706 (e.g., volatile memory), a non-volatile memory 712 to support processing operations. The CPU is further communicatively coupled to a network adapter hardware 716 to support input and output communications with external computing systems such as through the illustrated network 730.

The controller 700 further includes a data input/output (I/O) processor 714 that is able to be adapted to communicate with any type of equipment, such as the illustrated system components 728. The data input/output (I/O) processor in various examples is able to be configured to support any type of data communications connections including present day analog and/or digital techniques or via a future communications mechanism. A system bus 718 interconnects these system components.

In other examples, azimuth offset may be based not only on wind direction, but also air temperature, air humidity and other atmospheric affects.

### Information Processing System

The present subject matter can be realized in hardware, software, or a combination of hardware and software. A system can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein.

The present subject matter can also be embedded in a computer program product, which comprises all the features enabling the implementation of the methods described herein, and which—when loaded in a computer system—is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include computer readable storage medium embodying non-volatile memory, such as read-only memory (ROM), flash memory, disk drive memory, CD-ROM, and other permanent storage. In general, the computer readable medium embodies a computer program product as a computer readable storage medium that embodies computer readable program code with instructions to control a machine to perform the above described methods and realize the above described systems.

### NON-LIMITING EXAMPLES

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

1. A method of operating a green hydrogen generator, the method comprising:
determining operating parameters for a hydrogen producing electrolyzer to produce an amount of hydrogen at an output level;
determining an efficiency level of the hydrogen producing electrolyzer producing hydrogen at the output level;
determining a cost of an incremental amount of renewable energy;
determining a marginal amount of hydrogen that is generated by an incremental amount of renewable energy based on the efficiency level of the hydrogen producing electrolyzer;
determining an amount of incentive payments available for production of the marginal amount of hydrogen, wherein the amount of incentive payment is based on using the incremental amount of renewable energy to generate the marginal amount of hydrogen;
calculating a combination of the cost of the incremental amount of renewable energy given the efficiency level of the hydrogen producing electrolyzer and the amount of incentive payments by adjusting the cost of the incremental amount of renewable energy by the amount of incentive payments;
comparing the combination of the cost of the incremental amount of renewable energy and the amount of incentive payments to a revenue value of the marginal amount of hydrogen;
determining, based on a relationship between the combination of the cost of the incremental amount of renewable energy and the amount of incentive payments and the revenue value of the marginal amount of hydrogen, revised operating parameters for the hydrogen producing electrolyzer to one of increase or decrease an amount of hydrogen produced by the hydrogen producing electrolyzer; and
adjusting the hydrogen producing electrolyzer according to revised the operating parameters.

2. The method of claim 1, further comprising determining, based on a present output level of a hydrogen producing electrolyzer, an efficiency level of the hydrogen producing electrolyzer, and
wherein determining the marginal amount of hydrogen that is generated by an incremental amount of renewable energy is based on the efficiency level.

3. The method of claim 1, further comprising determining an estimated hydrogen storage capacity and wherein the adjusting is further based on the estimated hydrogen storage capacity.

4. The method of claim 1, wherein the cost of an incremental amount of renewable energy is based upon a value of the incremental amount of renewable energy that would be delivered to a power grid.

5. The method of claim 4, wherein the incremental amount of renewable energy is generated by a collocated renewable energy generation source.

6. The method of claim 1, further comprising:
determining a future amount of hydrogen to produce during a future time duration based on predicted renewable energy costs during the future time duration and a predicted hydrogen demand value during the future time duration; and
adjusting, prior to the future time duration and based on a maximum design ramp rate for the hydrogen producing electrolyzer, operating parameters of the hydrogen producing electrolyzer to adjust hydrogen output to cause the hydrogen producing electrolyzer to produce the future amount of hydrogen during the future time duration.

7. The method of claim 6, further comprising:
determining, based upon estimated revenue from selling electricity corresponding to the renewable energy at the future time duration based on forecast weather conditions at the future time duration and historical demand and pricing data, estimated costs per unit of the renewable energy at the future time duration;
determining incentive payments received per unit of hydrogen produced at the future time duration;
determining estimated revenue per unit of hydrogen produced at the future time duration based on estimated customer demand;
determining hydrogen storage capacity at the future time duration;
determining a rate of green hydrogen production at the future time duration based on a comparison of:
a combination of the estimated costs per unit of renewable electricity, the incentive payments available per unit of hydrogen produced at the future time duration, and an efficiency of the hydrogen producing electrolyzer at the determined rate of green hydrogen production, and
a combination of the estimated revenue per unit of hydrogen produced at the future time duration, and the hydrogen storage capacity at the future time duration; and
determine, based on the comparison, the operating parameters comprising at least one power set point or hydrogen output set point for a hydrogen producing electrolyzer.

8. A green hydrogen production controller, comprising:
an electrolyzer control module that, when operating, is configured to:
determining operating parameters for a hydrogen producing electrolyzer to produce an amount of hydrogen at an output level;
determining an efficiency level of the hydrogen producing electrolyzer producing hydrogen at the output level;
determine a marginal amount of hydrogen that is generated by an incremental amount of renewable energy based on the efficiency level of the hydrogen producing electrolyzer; and
a cost modelling module that, when operating, is configured to:
determine a cost of an incremental amount of renewable energy;
determine an amount of incentive payments available for production of the marginal amount of hydrogen, wherein the amount of incentive payment is based on using the incremental amount of renewable energy to generate the marginal amount of hydrogen; and
calculating a combination of the cost of the incremental amount of renewable energy given the efficiency level of the hydrogen producing electrolyzer and the amount of incentive payments by adjusting the cost of the incremental amount of renewable energy by the amount of incentive payments;
compare the combination of the cost of the incremental amount of renewable energy and the amount of incentive payments to a present revenue value of the marginal amount of hydrogen wherein the electrolyzer control module, when operating, is further configured to
determine, based on a relationship between the combination of the cost of the incremental amount of renewable energy and the amount of incentive payments and the present revenue value of the marginal amount of hydrogen, revised operating parameters for the hydrogen producing electrolyzer to one of increase or decrease an amount of hydrogen produced by the hydrogen producing electrolyzer; and
adjust the hydrogen producing electrolyzer according to the revised operating parameters.

9. The green hydrogen production controller of claim 8, wherein the electrolyzer control module, when operating, is further configured to determine, based on a present output level of a hydrogen producing electrolyzer, an efficiency level of the hydrogen producing electrolyzer, and to
determine the marginal amount of hydrogen that is generated by an incremental amount of renewable energy based on the efficiency level.

10. The green hydrogen production controller of claim 8, wherein the electrolyzer control module, when operating, is further configured to determine an estimated hydrogen storage capacity and to adjust further based on the estimated hydrogen storage capacity.

11. The green hydrogen production controller of claim 8, wherein the cost of an incremental amount of renewable energy is based upon a value of the incremental amount of renewable energy that would be delivered to a power grid.

12. The green hydrogen production controller of claim 11, wherein the incremental amount of renewable energy is generated by a collocated renewable energy generation source.

13. The green hydrogen production controller of claim 8, wherein the electrolyzer control module, when operating, is further configured to:
determine a future amount of hydrogen to produce during a future time duration based on predicted renewable energy costs during the future time duration and a predicted hydrogen demand value during the future time duration; and
adjust, prior to the future time duration and based on a maximum design ramp rate for the hydrogen producing electrolyzer, operating parameters of the hydrogen producing electrolyzer to adjust hydrogen output to cause the hydrogen producing electrolyzer to produce the future amount of hydrogen during the future time duration.

14. The green hydrogen production controller of claim 13, wherein the electrolyzer control module, when operating, is further configured to determine hydrogen storage capacity at the future time duration, and
wherein the cost modelling module, when operating, is further configured to
determining incentive payments received per unit of hydrogen produced at the future time duration;
determine estimated revenue per unit of hydrogen produced at the future time duration based on estimated customer demand; and
determine, based upon estimated revenue from selling electricity corresponding to the renewable energy at the future time duration based on forecast weather conditions at the future time and historical demand and pricing data, estimated costs per unit of renewable electricity at the future time duration;
determine a rate of green hydrogen production at the future time duration based on a comparison of:
a combination of the estimated costs per unit of renewable electricity, the incentive payments available per unit of hydrogen produced at the future time duration, and an efficiency of the hydrogen producing electrolyzer at the determined rate of green hydrogen production, and
a combination of the estimated revenue per unit of hydrogen produced at the future time duration, and the hydrogen storage capacity at the future time duration, and
wherein the electrolyzer control module, when operating, is further configured to determine, based on the comparison, the operating parameters comprising at least one power set point or hydrogen output set point for a hydrogen producing electrolyzer.

15. A computer program product for operating a green hydrogen generator, the computer program product comprising:
a non-transitory computer readable storage medium having computer readable program code embodied therewith, the computer readable program code comprising instructions for:
determining operating parameters for a hydrogen producing electrolyzer to produce an amount of hydrogen at an output level;
determining an efficiency level of the hydrogen producing electrolyzer producing hydrogen at the output level;
determining a cost of an incremental amount of renewable energy;
determining a marginal amount of hydrogen that is generated by an incremental amount of renewable energy based on the efficiency level of the hydrogen producing electrolyzer;
determining an amount of incentive payments available for production of the marginal amount of hydrogen, wherein the amount of incentive payment is based on using the incremental amount of renewable energy to generate the marginal amount of hydrogen;
calculating a combination of the cost of the incremental amount of renewable energy given the efficiency level of the hydrogen producing electrolyzer and the amount of incentive payments by adjusting the cost of the incremental amount of renewable energy by the amount of incentive payments;
comparing the combination of the cost of the incremental amount of renewable energy and the amount of incentive payments to a present revenue value of the marginal amount of hydrogen;
determining, based on a relationship between the combination of the cost of the incremental amount of renewable energy and the amount of incentive payments and the present revenue value of the marginal amount of hydrogen, revised operating parameters of for the hydrogen producing electrolyzer to one of increase or decrease an amount of hydrogen produced by the hydrogen producing electrolyzer; and
adjusting the hydrogen producing electrolyzer according to the revised operating parameters.

16. The computer program product of claim 15, further comprising determining an estimated hydrogen storage capacity and wherein the adjusting is further based on the estimated hydrogen storage capacity.

17. The computer program product of claim 15, wherein the cost of an incremental amount of renewable energy is based upon a value of the incremental amount of renewable energy that would be delivered to a power grid.

18. The computer program product of claim 17, wherein the incremental amount of renewable energy is generated by a collocated renewable energy generation source.

19. The computer program product of claim 15, further comprising:
determining a future amount of hydrogen to produce during a future time duration based on predicted renewable energy costs during the future time duration and a predicted hydrogen demand value during the future time duration; and
adjusting, prior to the future time duration and based on a maximum design ramp rate for the hydrogen producing electrolyzer, operating parameters of the hydrogen producing electrolyzer to adjust hydrogen output to cause the hydrogen producing electrolyzer to produce the future amount of hydrogen during the future time duration.

20. The computer program product of claim 19, further comprising:
determining, based upon estimated revenue from selling electricity corresponding to the renewable energy at the future time duration based on forecast weather conditions at the future time duration and historical demand and pricing data, estimated costs per unit of renewable electricity at the future time duration;
determining incentive payments received per unit of hydrogen produced at the future time duration;
determine estimated revenue per unit of hydrogen produced at the future time duration based on estimated customer demand;
determine hydrogen storage capacity at the future time duration;
determine a rate of green hydrogen production at the future time duration based on a comparison of:
a combination of the estimated costs per unit of renewable electricity, the incentive payments available per unit of hydrogen produced at the future time duration, and an efficiency of the hydrogen producing electrolyzer at the determined rate of green hydrogen production, and
a combination of the estimated revenue per unit of hydrogen produced at the future time duration, and the hydrogen storage capacity at the future time duration; and
determine, based on the comparison, the operating parameters comprising at least one power set point or hydrogen output set point for a hydrogen producing electrolyzer.
